(19) United States
(12) Patent Application Publication
(10) Pub. No.: US 2024/0184118 A1
(43) Pub. Date: Jun. 6, 2024

(54) Infrared Coatings for Gaze Tracking Systems

(71) Applicant: Apple Inc., Cupertino, CA (US)

(72) Inventors: Brian S. Lau, Seattle, WA (US); Michael J. Oudenhoven, San Francisco, CA (US); Cameron A. Harder, San Francisco, CA (US)

(21) Appl. No.: 18/444,284

(22) Filed: Feb. 16, 2024

Related U.S. Application Data
(63) Continuation of application No. PCT/US22/43244, filed on Sep. 12, 2022.
(60) Provisional application No. 63/247,066, filed on Sep. 22, 2021.

(51) Int. Cl. G02B 27/01; G02B 5/20; G02B 5/28; G02B 27/00

(52) U.S. Cl. CPC G02B 27/0172; G02B 5/208; G02B 5/282; G02B 27/0093; G02B 2027/0114

(57) ABSTRACT

A head-mounted device may include near-eye displays and gaze tracking components to track a user's gaze. The head-mounted device may include an optical system, including a waveguide and optional lenses to guide images produced by display modules to an eye box. The gaze tracking components may include infrared emitters that emit infrared light toward the user's eyes and infrared sensors that detect infrared light that has been reflected from the user's eyes. To reduce interference with the gaze tracking components from environmental infrared light, the optical system may include an infrared-reflective coating and an infrared-absorptive coating. The infrared-reflective and infrared-absorptive coatings may be formed on the optional lenses or on other transparent structures in the optical system. Together, the infrared-reflective and infrared-absorptive coatings may reduce an amount of environmental infrared light that reaches the gaze tracking components and reduce a thermal load on internal components within the head-mounted device.

This application is a continuation of international patent application No. PCT/US2022/043244, filed Sep. 12, 2022, which claims priority to U.S. provisional patent application No. 63/247,066, filed Sep. 22, 2021, which are hereby incorporated by reference herein in their entireties.

### FIELD

This relates generally to optical systems and, more particularly, to optical systems for displays.

### BACKGROUND

Electronic devices may include displays that present images to a user's eyes. For example, devices such as virtual reality and augmented reality headsets may include displays with optical elements that allow users to view the displays. To ensure that information is presented to a user correctly, gaze tracking systems may be used to determine a location of the user's gaze.

It can be challenging to design devices such as these. If care is not taken, environmental light may interfere with the gaze tracking systems. Additionally, the devices may experience high thermal load in response to environmental infrared light.

### SUMMARY

An electronic device such as a head-mounted device may have one or more near-eye displays that produce images for a user. The head-mounted device may be a pair of virtual reality glasses or may be an augmented reality headset that allows a viewer to view both computer-generated images and real-world objects in the viewer's surrounding environment.

The display may include a display module, gaze tracking components, and a waveguide. The display module may generate image light at visible wavelengths. One or more lenses may be incorporated into the device to present the computer-generated images and/or real-world objects to the user's eyes. The waveguide may guide the visible light from the display module to an eye box of the user.

The gaze tracking components may include an infrared emitter and an infrared sensor. The infrared emitter may emit infrared light. The infrared sensor may detect light that has been emitted by the infrared emitter and reflected off of an eye of the user. Control circuitry may track the user's gaze based on the detected infrared light.

To ensure that environment light does not interfere with the infrared detector (i.e., the infrared detector does not detect infrared light from the environment instead of eye that has reflected from the eye of a user), infrared-absorptive and infrared-reflective coatings may overlap the eye box. These coatings may reduce the amount of stray infrared light that reaches the infrared sensor and reduce the thermal load on internal components of the device.

### BRIEF DESCRIPTION OF THE DRAWINGS

FIG. 1 is a diagram of an illustrative electronic device having display and gaze tracking capabilities in accordance with an embodiment.

FIG. 2 is a cross-sectional top view of an illustrative electronic device having display and gaze tracking capabilities in accordance with an embodiment.

FIG. 3 is a diagram of an illustrative display module having a waveguide, lenses, and gaze tracking components in accordance with an embodiment.

FIG. 4 is a diagram of an illustrative optical module having a waveguide, first and second bias lenses, and infrared-absorptive and infrared-reflective coatings on one of the bias lenses in accordance with an embodiment.

FIG. 5 is a diagram of an illustrative optical module having a waveguide, first and second cover structures, an infrared-reflective coating on the first cover structure, and an infrared-absorptive coating on the second cover structure in accordance with an embodiment.

FIG. 6 is a graph of an illustrative relationship between reflectivity and wavelength of light for an infrared-reflective coating in accordance with an embodiment.

FIG. 7 is a graph of an illustrative relationship between transmission and wavelength of light for an infrared-absorptive coating in accordance with an embodiment.

### DETAILED DESCRIPTION

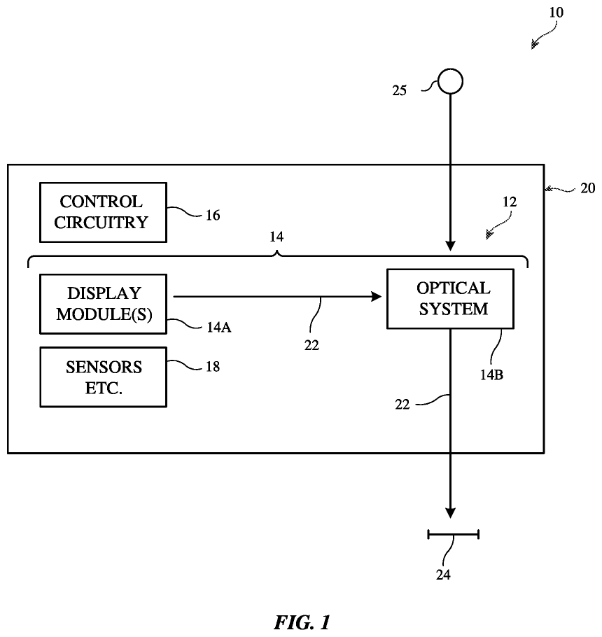

An illustrative system having a device with one or more near-eye display systems is shown in FIG. 1. System 10 may be a head-mounted device having one or more displays such as near-eye displays 14 mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B (also referred to as optical assemblies 14B herein). Display modules 14A may be mounted in a support structure such as support structure 20 (also referred to as housing 20 herein). Each display module 14A may emit light 22 (sometimes referred to herein as image light 22) that is redirected towards a user's eyes at eye box 24 using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide system 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., world-facing cameras such as image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.). If desired, components 18 may include gaze tracking sensors that gather gaze image data from a user's eye at eye box 24 to track the direction of the user's gaze in real time. The gaze tracking sensors may include at least one infrared (IR) emitter that emits infrared or near-infrared light that is reflected off of portions of the user's eyes. At least one infrared image sensor may gather infrared image data from the reflected infrared or near-infrared light. Control circuitry 16 may process the gathered infrared image data to identify and track the direction of the user's gaze, for example.

Display modules 14A (sometimes referred to herein as display engines 14A, light engines 14A, or projectors 14A) may include reflective displays (e.g., displays with a light source that produces illumination light that reflects off of a reflective display panel to produce image light such as liquid crystal on silicon (LCOS) displays, ferroelectric liquid crystal on silicon (fLCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical assembly 14B may be selected so that any gap present between the displays will not be visible to a user (e.g., so that the images of the left and right displays overlap or merge seamlessly).

If desired, optical assembly 14B may contain components (e.g., an optical combiner, etc.) to allow real-world image light from real-world images or objects 25 to be combined optically with virtual (computer-generated) images such as virtual images in image light 22. For example, optical system 14B may include one or more lenses that display real-world content and computer-generated content in a realistic fashion to the user. In this type of system, which is sometimes referred to as an augmented reality system, a user of system 10 may view both real-world content and computer-generated content that is overlaid on top of the real-world content. Camera-based augmented reality systems may also be used in system 10 (e.g., in an arrangement in which a world-facing camera captures real-world images of object 25 and this content is digitally merged with virtual content at optical assembly 14B). However, system 10 may be a virtual reality system (e.g., a system that does not convey real-world images to a user) or a mixed reality system, if desired.

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

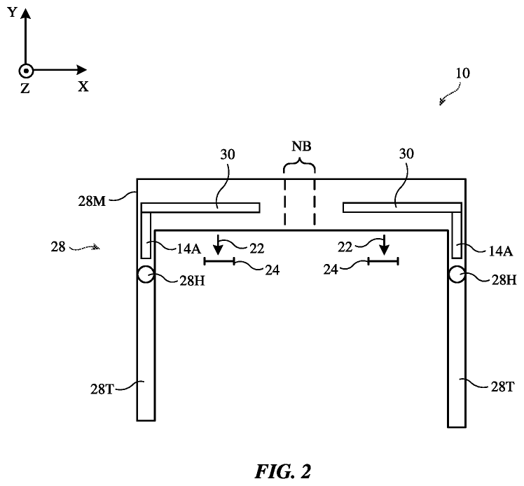

In an illustrative configuration, devices 10 include a head-mounted device such as a pair of glasses (sometimes referred to as augmented reality glasses). A cross-sectional top view of device 10 in an illustrative configuration in which device 10 is a pair of glasses is shown in FIG. 2. A shown in FIG. 2, device 10 may include housing 28 (also referred to as support structure 28 herein). Housing 28 may include a main portion (sometimes referred to as a glasses frame) such as main portion 28M and temples 28T that are coupled to main portion 28M by hinges 28H. Nose bridge portion NB may have a recess that allows housing 28 to rest on a nose of a user while temples 28T rest on the user's ears.

Images may be displayed in eye boxes 24 using display modules 14A (e.g., projector displays, sometimes referred to as light engines) and waveguides 30 (which may be at least a portion of optical system 14B of FIG. 1). Waveguides 30 may have input couplers that receive light from projector displays 14A. Waveguides 30 may include one or more stacked substrates (e.g., stacked planar and/or curved layers sometimes referred to herein as waveguide substrates) of optically transparent material such as plastic, polymer, glass, etc. Although waveguides 30 are shown as planar in FIG. 2, waveguides 30 may be at least partially curved or bent, if desired.

If desired, display modules 14A may include a spatial light modulator that modulates illumination light produced by light sources (e.g., using image data) to produce image light 22 (e.g., image light that includes an image as identified by the image data). The spatial light modulator may be a reflective spatial light modulator (e.g., a DMD modulator, an LCOS modulator, an fLCOS modulator, etc.) or a transmissive spatial light modulator (e.g., an LCD modulator). In other implementations, display modules 14A may include an emissive display panel such as an array of LEDs, OLEDs, uLEDs, lasers, or other light sources instead of a spatial light modulator.

The image light generated by display modules 14A is then guided laterally (along the X axis) within waveguides 30 in accordance with the principal of total internal reflection. Each waveguide 30 may have an output coupler in front of a respective eye box 24. The output coupler couples the image light out of the waveguide 30 and directs an image towards the associated eye box 24 for viewing by a user (e.g., a user whose eyes are located in eye boxes 24), as shown by arrows 22. Input and output couplers for device 10 may be formed from gratings and/or other optical structures.

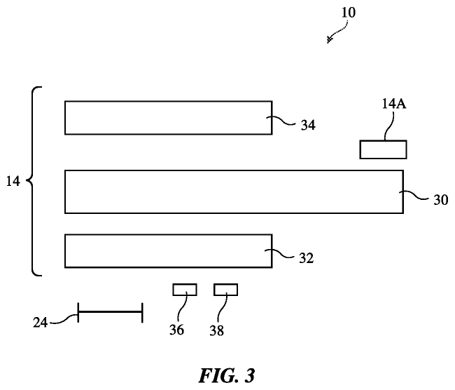

Although not shown in FIG. 2, it may be desirable to perform gaze tracking operations. For example, tracking a gaze of the user of head-mounted device 10 may allow control circuitry, such as control circuitry 16 of FIG. 1, to display information to the user based on the user's gaze. An example of a portion of device 10 that may include gaze tracking circuitry is shown in FIG. 3.

As shown in FIG. 3, device 10 may include display 14. The portion of device 10 shown in FIG. 3 may display images to a single eye box 24 (i.e., device 10 may have two sets of the assembly shown in FIG. 3, one for each eye). However, this is merely illustrative. Any number of components shown in FIG. 3 may be used in device 10.

Display 14 may include display module 14A and waveguide 30. As discussed above in connection with FIG. 2, images may be displayed in eye box 24 using display module 14A (e.g., projector displays, sometimes referred to as light engines) and waveguide 30 (which may be at least a portion of optical assembly 14B of FIG. 1). Waveguide 30 may have input couplers that receive light from projector displays 14A. Waveguide 30 may include one or more stacked substrates (e.g., stacked planar and/or curved layers sometimes referred to herein as waveguide substrates) of optically transparent material such as plastic, polymer, glass, etc. Although waveguide 30 is shown as planar in FIG. 3, waveguide 30 may be at least partially curved or bent, if desired.

If desired, display module 14A may include a spatial light modulator that modulates illumination light produced by light sources (e.g., using image data) to produce light for the images (e.g., image light that includes an image as identified by the image data). The spatial light modulator may be a reflective spatial light modulator (e.g., a DMD modulator, an LCOS modulator, an fLCOS modulator, etc.) or a transmissive spatial light modulator (e.g., an LCD modulator). In other implementations, display module 14A may include an emissive display panel such as an array of LEDs, OLEDs, uLEDs, lasers, or other light sources instead of a spatial light modulator.

The image light generated by display module 14A is then guided laterally within waveguide 30 in accordance with the principal of total internal reflection. Each waveguide 30 may have an output coupler in front of a respective eye box 24. The output coupler couples the image light out of the waveguide 30 and directs an image towards eye box 24 for viewing by a user (e.g., a user whose eyes are located in eye boxes 24. Input and output couplers for device 10 may be formed from gratings and/or other optical structures.

Display 14 may also include one or more transparent structures or lenses, such as lens 32 and lens 34 of FIG. 3. Lens 34 may be interposed between waveguide 30 and real-world objects. Lens 32 may be interposed between waveguide 30 and eye box 24. Lenses 32 and 34 may be transparent to allow real-world image light from real-world objects to pass to eye box 24 for viewing by the user. At the same time, the user may view virtual images associated with computer-generated content that are directed out of waveguide 30 and through lens 32 to eye box 24.

The strength (sometimes referred to as the power or diopter) of lens 32 can be selected to place virtual images in image light at a desired distance from device 10. For example, it may be desirable to place computer-generated content such as text, icons, moving images, or other content at a certain virtual image distance. The placement of the virtual object at that distance can be accomplished by appropriate selection of the strength of lens 32. Lens 32 may be a negative lens for users whose eyes do not have refraction errors. The strength (larger net negative power) of lens 32 can therefore be selected to adjust the distance of the virtual object.

If desired, lens 34 may have a complementary power value (e.g., a positive power with a magnitude that matches the magnitude of the negative power of lens 32). For example, if lens 32 has a power of −2.0 diopter, lens 34 may have an equal and opposite power of +2.0 diopter (as an example). In this type of arrangement, the positive power of lens 34 cancels the negative power of lens 32. As a result, the overall power of lenses 34 and 32 taken together will be 0 diopter. This allows a viewer to view real-world objects without optical influence from lenses 32 and 34. For example, a real-world object located far away from device 10 (effectively at infinity), may be viewed as if lenses 32 and 34 were not present. Lens 32 may therefore sometimes be referred to herein as biasing lens 32 whereas lens 34 is sometimes referred to herein as compensation lens 34.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical assembly). For example, a real-world object located at a distance of 2 m from device 10 (e.g., a real-world object being labeled by a virtual text label at a virtual image distance of 2 m) will optically appear to be located 2 m from device 10. This is merely illustrative and, if desired, lenses 32 and 34 need not be complementary lenses (e.g., lenses 32 and 34 may have any desired optical powers).

Some users may require vision correction. Vision correction may be provided using tunable lenses and/or fixed (e.g., removable) lenses (sometimes referred to as supplemental lenses, vision correction lenses, removable lenses, or clip-on lenses). For example, vision correction may be provided for a user who has astigmatism by adding a removable astigmatism correction lens to the display system of FIG. 3. Other vision correction lenses may also be used, if desired. In general, the vision correction lenses may include lenses to correct for ametropia (eyes with refractive errors) such as lenses to correct for nearsightedness (myopia), lenses to correct for farsightedness (hyperopia), and lenses to correct for astigmatism, prism lenses to correct for skewed vision, lenses to help accommodate age-related reductions in the range of accommodation exhibited by the eyes (sometimes referred to as presbyopia), and/or other vision disorders. Lens 32, lens 34, and/or additional lenses may be used to provide vision correction.

In order to perform gaze tracking operations, device 10 may also include gaze tracking components 36 and 38. Gaze tracking components may include an infrared light source such as infrared emitter 36 and an infrared sensor such as infrared sensor 38. Infrared emitter 36 may emit infrared light. While referred to herein as infrared light, infrared light may include light at infrared and/or near-infrared wavelengths (e.g., wavelengths from 700 nm up to 1000 microns). An example in which infrared light includes light around 950 nm (e.g., 940 nm) is sometimes described herein as an example. Infrared emitter 36 may include one or more infrared lasers, infrared LEDs, infrared OLEDs, infrared uLEDs, and/or any other desired infrared light source(s).

Infrared emitter 36 may direct infrared light toward eye box 24. The infrared light may be emitted directly at eye box 24, may be directed into waveguide 30 to be guided to eye box 24, may be directed to an additional waveguide to be guided to eye box 24, or may otherwise reach eye box 24. Regardless of the method in which infrared light reaches eye box 24, the infrared light may illuminate portions of the user's eye, creating glints. These glints may be infrared light that is reflected off the user's eye. Infrared sensor 38 may detect the glints after they have reflected from the user's eye. A direction of the user's gaze may be determined based on the glints detected by infrared sensor 38. If desired, control circuitry, such as control circuitry 16 of FIG. 1, may adjust the image produced by display module 14A (also referred to as display 14A herein) based on the user's gaze. Although infrared emitter 36 and infrared sensor 38 have been described in the context of performing gaze tracking operations, this is merely illustrative. In general, device 10 may include any desired number of infrared components that perform any desired function.

Although FIGS. 1-3 describe electronic device 10 as having gaze tracking and near-eye displays, this is merely illustrative. Electronic device 10 may be any desired device with gaze tracking operations. For example, electronic device 10 may be smart glasses that include gaze tracking, but do not include near-eye displays. In this example, electronic device 10 may include sensors, such as cameras, light sensors, proximity sensors, and/or any other desired sensors; and/or may communicate with one or more external devices, such as cell phones, computers, or other devices. The gaze tracking circuitry (also referred to as a gaze tracker herein) may be used by electronic device 10 and/or the external device(s) to determine a user's gaze, and components within device 10 may be adjusted based on the user's gaze. Alternatively or additionally, the external device(s) may adjust components within the external device(s), such as displays, cameras, sensors, or other components based on the user's gaze. However, these examples are merely illustrative. In general, device 10 may be any desired electronic device that includes gaze tracking operations.

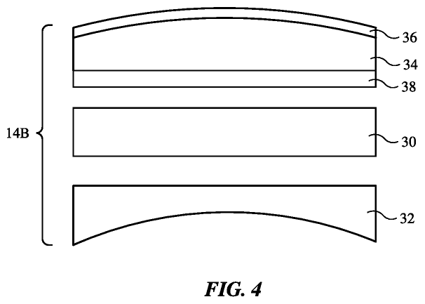

Environmental light incident on device 10 may interfere with these gaze tracking capabilities. In particular, infrared environmental light may wash out portions of the user's eye or create false glints, thereby rendering the gaze tracking performed by infrared sensor 38 inaccurate (e.g., infrared sensor 38 may be unable to determine the user's gaze or may detect the false glints, thereby attributing an inaccurate gaze to the user). Examples of coatings that may be incorporated into device 10 to reduce interference are shown in FIG. 4.

As shown in FIG. 4, optical system 14B may include waveguide 30, lens 32, and lens 34, which may have substantially similar properties to those discussed above in connection with FIG. 3. To prevent or reduce infrared light passing through optical system 14B (and thereby interfering with gaze tracking operation), infrared-reflective coating 36 and infrared-absorptive coating 38 may be applied to lens 34.

Infrared-reflective coating 36 may be a dichroic filter. In particular, infrared-reflective coating 36 may reflect infrared light, while transmitting visible light. Infrared-reflective coating 36 may therefore sometimes be referred to as a hot mirror dichroic filter. Infrared-reflective coating 36 may be applied to lens 34 via a deposition process, such as physical vapor deposition (PVD), chemical vapor deposition (CVD), or any other desired deposition process. Infrared-reflective coating 36 may include any desired number of layers (e.g., thin-film interference layers) that together reflect a desired amount of infrared light.

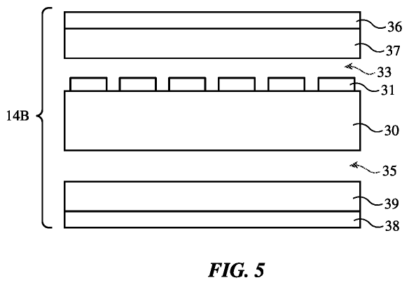

Although infrared-reflective coating 36 is applied to lens 34 in FIG. 4, this is merely illustrative. Infrared-reflective coating 36 may be applied to another layer within optical assembly 14B, such as lens 32, or a cover layer that overlaps waveguide 30. An example of this arrangement is shown in FIG. 5.

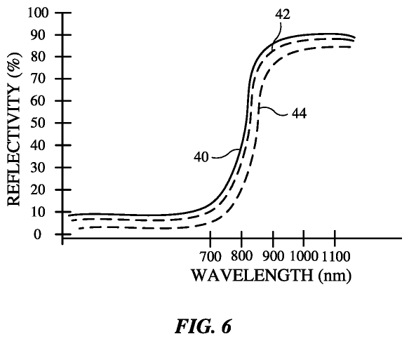

As shown in FIG. 5, infrared-reflective coating 36 may be applied to waveguide cover structure 37, which may be separated from waveguide 30 by air gap 33. However, these locations for infrared-reflective coating 36 are merely illustrative. In general, infrared-reflective coating 36 may be applied to any desired surface within optical assembly 14B. Regardless of the surface on which infrared-reflective coating 36 is applied, infrared-reflective coating 36 may be a stop filter that reflects infrared light while allowing visible light to pass. A graph showing an illustrative relationship between wavelength and reflectivity for infrared-reflective coating 36 is shown in FIG. 6.

As shown in FIG. 6, infrared-reflective coating 36 may reflect different amounts of light depending on the wavelength of the light. Moreover, each of the curves 40, 42, and 44 may correspond to different angles of incidence of the light on infrared reflective-coating 36. For example, curve 40 may correspond to an angle of incidence of 50°, curve 42 may correspond to an angle of incidence of 40°, and curve 44 may correspond to an angle of incidence of 30°. These angles of incidence may be measured from a normal to infrared-reflective coating 36. However, these angles of incidence are merely illustrative. In general, curves 40, 42, and 44 may correspond to any angles of incidence.

As shown in FIG. 6, infrared-reflective coating 36 may reflect at least 80% of infrared light, at least 85% of infrared light, less than 95% of infrared light, or at least 90% of infrared light, as examples. In some examples, infrared-reflective coating may reflect at least 80% of infrared light at 850 nm, 900 nm, 1000 nm, 940 nm, or any other desired wavelength. Infrared-reflective coating 36 may transmit at least 80%, at least 90%, or at least 95% of visible light (i.e., light with a wavelength of 380 nm to 750 nm).

Because the reflectivity of infrared-reflective coating 36 is dependent on the angle of incidence of light on the coating, it may be desirable for infrared-reflective coating 36 to reflect over 80% of infrared light at a given infrared wavelength (e.g., 940 nm) for light that is incident on the coating at 45° to 60° from an axis normal to infrared-reflective coating 36. In this way, infrared-reflective coating 36 may reflect light at a steep angle of incidence while device 10 is in use, which may reflect a large proportion of infrared light from sunlight and overhead lights. However, these examples are merely illustrative. In general, infrared-reflective coating 36 may reflect any desired amount of infrared light from any desired angle of incidence and at any desired wavelength.

Returning to FIG. 4, infrared-absorptive coating 38 may be applied to an opposing surface of lens 34 from infrared-reflective coating 36. For example, infrared-reflective coating 36 may face an exterior of device 10 (i.e., be interposed between lens 34 and real-world objects), while infrared-absorptive coating 38 may face an interior of device 10 (i.e., be interposed between lens 34 and an eye box of a user).

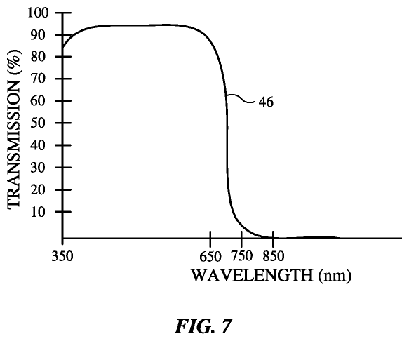

Infrared-absorptive coating 38 may be a laminated film on the surface of lens 34, or may be coated onto lens 34 in any desired manner. However, the position of coating 38 on a surface of lens 34 is merely illustrative. As shown in FIG. 5, for example, coating 38 may be applied to substrate 39, which may be spaced apart from waveguide 30 by air gap 35. Alternatively, coating 38 could be applied to a surface of lens 32 in FIG. 4. In general, infrared-absorptive coating 38 may be in any desired position within optical system 14B. Regardless of the position of infrared-absorptive coating 38 within optical system 14B, infrared-absorptive coating 38 may transmit light at visible wavelengths and absorb light at infrared wavelengths. A graph showing an illustrative relationship between wavelength and transmission for infrared-absorptive coating 38 is shown in FIG. 7.

As shown in FIG. 7, infrared-absorptive coating 38 may transmit at least 90%, at least 85%, less than 95%, or at least 80% of light across visible wavelengths. For example, infrared-absorptive coating 38 may transmit light between 350 nm and 750 nm, or any other desired range. Infrared-absorptive coating 38 may absorb infrared (and near-infrared light). For example, absorptive coating 38 may absorb at least 90%, at least 95% at least 85%, at least 80%, or any other desired amount of light over 750 nm, over 740 nm, over 800 nm, or any other desired range.

Although infrared-reflective coating 36 may reflect most infrared light (as shown in FIG. 6), infrared-reflective coating 36 does not exhibit 100% reflectance in infrared, and it is angularly dependent. Therefore, some infrared light may pass through infrared-reflective coating 36. Infrared-absorptive coating 38 may absorb the infrared light that has passed through infrared-reflective coating 36, thereby preventing infrared light from interfering with gaze tracking operations in device 10.

Moreover infrared-reflective coating 36 may prevent a majority of infrared light from reaching the internal portion of device 10, thereby reducing the thermal load on device 10. In other words, device 10 will not heat up as much due to infrared light incident on the device, thereby protecting components within device 10, such as the displays and circuitry of FIG. 1. In particular, some waveguides, such as waveguide 30, may be sensitive to temperature, and increased temperatures could cause condensation on lenses, such as lenses 34 and 32. Infrared-reflective coating 36 may block infrared light from these components, reducing the thermal load on the components.

Although FIG. 4 shows lenses 32 and 34, which are used to augment the real-world and computer-generated objects seen by a user, this is merely illustrative. It may be desirable to have displays without lenses or with other components. An example of optical assembly 14B without lenses 32 and 34 is shown in FIG. 5.

As shown in FIG. 5, waveguide 30 may have an overlying cover structure 37 and underlying cover structure 39. Cover structure 37 may be between waveguide 30 and the exterior of device 10 (i.e., between waveguide 30 and real-world objects that are viewable by a user when wearing device 10), while cover structure 39 may be between waveguide 30 and interior of device 10 (i.e., between waveguide 30 and an eye box of the user). Cover structures 37 and 39 may be separated from waveguide 30 by air gaps 33 and 35, respectively. Cover structures 37 and 39 may be, for example, cover glasses, or other transparent structures.

As discussed above, infrared-reflective coating 36 may be formed on cover structure 37, and infrared-absorptive coating 38 may be formed on cover structure 39. However, this is merely illustrative. In general, infrared-reflective coating 36 and infrared-absorptive coating 38 may be formed anywhere in optical assembly 14B. In one example, infrared-absorptive coating 38 may be formed on an opposing surface of cover structure 37 from infrared-reflective coating 36.

Although waveguide 30 has been shown in FIGS. 3-5 as being a single layer, this is merely illustrative. Waveguide 30 may include any desired number of layers. If desired, each layer of waveguide 30 may have gratings 31 to direct light toward the eye box of the user. However, this is merely illustrative. In general, waveguide 30 may have any coupling structure to direct light toward the eye box of the user after it has traveled through waveguide 30.

In accordance with an embodiment, a system is provided that includes a head-mounted support structure, a display coupled to the head-mounted support structure that is configured to provide an image containing computer-generated content, a gaze tracker, and an optical assembly that provides the image to an eye box while allowing a real-world object to be viewed through the optical assembly from the eye box, the optical assembly includes an infrared-absorptive coating and an infrared-reflective coating.

In accordance with another embodiment, the gaze tracker includes an infrared emitter and an infrared sensor, and the optical assembly includes a waveguide that guides the image to the eye box, a biasing lens interposed between the waveguide and the eye box, and a compensation lens interposed between the waveguide and the real-world object, the infrared-reflective coating is a dichroic filter formed on an outer surface of the compensation lens and the infrared-absorptive coating is a laminated film on an opposing inner surface of the compensation lens.

In accordance with another embodiment, the optical assembly includes a waveguide that guides the image to the eye box and the infrared-reflective coating is interposed between the waveguide and the real-world object.

In accordance with another embodiment, the infrared-absorptive coating is interposed between the infrared-reflective coating and the waveguide.

In accordance with another embodiment, the optical assembly includes a first lens interposed between the waveguide and the eye box, and a second lens interposed between the waveguide and the real-world object, the second lens has a first surface that faces the waveguide and an opposing second surface, the infrared-absorptive coating is on the first surface, and the infrared-reflective coating is on the second surface.

In accordance with another embodiment, the infrared-absorptive coating is interposed between the waveguide and the eye box.

In accordance with another embodiment, the optical assembly includes a first cover structure interposed between the waveguide and the eye box, the infrared-absorptive coating is on the first cover structure, and a second cover structure interposed between the waveguide and the real-world object, the infrared-reflective coating is on the second cover structure.

In accordance with another embodiment, the first cover structure is separated from the waveguide by a first air gap and the second cover structure is separated from the waveguide by a second air gap.

In accordance with another embodiment, the infrared-absorptive coating and the infrared-reflective coating are configured to reduce interference with gaze tracking operations from environmental infrared light.

In accordance with another embodiment, the infrared-reflective coating is a dichroic filter.

In accordance with another embodiment, the dichroic filter is configured to reflect at least 80% of infrared light that is incident on the dichroic filter between 45° and 60° from an axis normal to the infrared-reflective coating.

In accordance with another embodiment, the dichroic filter transmits at least 80% of visible light incident on the dichroic filter.

In accordance with another embodiment, the infrared-absorptive coating is a laminated film that transmits at least 80% of visible light incident on the infrared-absorptive coating and that absorbs at least 90% of infrared light incident on the infrared-absorptive coating.

In accordance with an embodiment, a system is provided that includes a head-mounted support structure, an infrared emitter and an infrared sensor configured to be used for gaze tracking, and an optical assembly that includes a first transparent structure and a second transparent structure, the optical assembly includes an infrared-absorptive coating and an infrared-reflective coating on the first transparent structure, and the infrared-absorptive coating and the infrared-reflective coating are configured to reduce an amount of environmental infrared light that reaches the infrared sensor.

In accordance with another embodiment, the system includes a display coupled to the head-mounted support structure that is configured to provide an image containing computer-generated content, the optical assembly includes a waveguide that provides the image to an eye box, and the waveguide is interposed between the first transparent structure and the second transparent structure.

In accordance with another embodiment, the first transparent structure is a compensation lens that has opposing first and second surfaces, the infrared-reflective coating is on the first surface, and the infrared-absorptive coating is on the second surface.

In accordance with another embodiment, the infrared-reflective coating is a dichroic filter, the infrared-absorptive coating is a laminated film, and the second transparent structure is a biasing lens.

In accordance with another embodiment, the infrared-reflective coating and the infrared-absorptive coating are configured to reduce a thermal load on an internal portion of the head-mounted support structure.

In accordance with an embodiment, a system is provided that includes a head-mounted support structure, a display coupled to the head-mounted support structure that is configured to provide an image containing computer-generated content, a gaze tracker, and an optical assembly that provides the image to an eye box, the optical assembly includes a waveguide that guides the image to an eye box, and an infrared-absorptive coating and an infrared-reflective coating that are configured to reduce an amount of environmental infrared light that reaches the gaze tracker.

In accordance with another embodiment, the gaze tracker includes an infrared emitter and an infrared detector, the infrared-reflective coating is a dichroic filter, and the dichroic filter and the infrared-reflective coating are configured to reduce a thermal load on an internal portion of the head-mounted support structure.

The foregoing is merely illustrative and various modifications can be made to the described embodiments. The foregoing embodiments may be implemented individually or in any combination.

What is claimed is:

1. A system, comprising:
a head-mounted support structure;
a display coupled to the head-mounted support structure that is configured to provide an image containing computer-generated content;
a gaze tracker; and
an optical assembly that provides the image to an eye box while allowing a real-world object to be viewed through the optical assembly from the eye box, wherein the optical assembly includes an infrared-absorptive coating and an infrared-reflective coating.

2. The system defined in claim 1 wherein the gaze tracker comprises an infrared emitter and an infrared sensor, and wherein the optical assembly further comprises:
a waveguide that guides the image to the eye box;
a biasing lens interposed between the waveguide and the eye box; and
a compensation lens interposed between the waveguide and the real-world object, wherein the infrared-reflective coating is a dichroic filter formed on an outer surface of the compensation lens and the infrared-absorptive coating is a laminated film on an opposing inner surface of the compensation lens.

3. The system defined in claim 1 wherein the optical assembly comprises a waveguide that guides the image to the eye box and wherein the infrared-reflective coating is interposed between the waveguide and the real-world object.

4. The system defined in claim 3 wherein the infrared-absorptive coating is interposed between the infrared-reflective coating and the waveguide.

5. The system defined in claim 4 wherein the optical assembly further comprises:
a first lens interposed between the waveguide and the eye box; and
a second lens interposed between the waveguide and the real-world object, wherein the second lens has a first surface that faces the waveguide and an opposing second surface, wherein the infrared-absorptive coating is on the first surface, and wherein the infrared-reflective coating is on the second surface.

6. The system defined in claim 3 wherein the infrared-absorptive coating is interposed between the waveguide and the eye box.

7. The system defined in claim 6 wherein the optical assembly further comprises:
a first cover structure interposed between the waveguide and the eye box, wherein the infrared-absorptive coating is on the first cover structure; and
a second cover structure interposed between the waveguide and the real-world object, wherein the infrared-reflective coating is on the second cover structure.

8. The system defined in claim 7 wherein the first cover structure is separated from the waveguide by a first air gap and wherein the second cover structure is separated from the waveguide by a second air gap.

9. The system defined in claim 1 wherein the infrared-absorptive coating and the infrared-reflective coating are configured to reduce interference with gaze tracking operations from environmental infrared light.

10. The system defined in claim 1 wherein the infrared-reflective coating is a dichroic filter.

11. The system defined in claim 10 wherein the dichroic filter is configured to reflect at least 80% of infrared light that is incident on the dichroic filter between 45° and 60° from an axis normal to the infrared-reflective coating.

12. The system defined in claim 11 wherein the dichroic filter transmits at least 80% of visible light incident on the dichroic filter.

13. The system defined in claim 11 wherein the infrared-absorptive coating is a laminated film that transmits at least 80% of visible light incident on the infrared-absorptive coating and that absorbs at least 90% of infrared light incident on the infrared-absorptive coating.

14. A system, comprising:
a head-mounted support structure;
an infrared emitter and an infrared sensor configured to be used for gaze tracking; and
an optical assembly that includes a first transparent structure and a second transparent structure, wherein the optical assembly comprises an infrared-absorptive coating and an infrared-reflective coating on the first transparent structure, and wherein the infrared-absorptive coating and the infrared-reflective coating are configured to reduce an amount of environmental infrared light that reaches the infrared sensor.

15. The system defined in claim 14 further comprising:
a display coupled to the head-mounted support structure that is configured to provide an image containing computer-generated content, wherein the optical assembly comprises a waveguide that provides the image to an eye box, and wherein the waveguide is interposed between the first transparent structure and the second transparent structure.

16. The system defined in claim 15 wherein the first transparent structure is a compensation lens that has opposing first and second surfaces, wherein the infrared-reflective coating is on the first surface, and wherein the infrared-absorptive coating is on the second surface.

17. The system defined in claim 16 wherein the infrared-reflective coating is a dichroic filter, wherein the infrared-absorptive coating is a laminated film, and wherein the second transparent structure is a biasing lens.

18. The system defined in claim 17 wherein the infrared-reflective coating and the infrared-absorptive coating are configured to reduce a thermal load on an internal portion of the head-mounted support structure.

19. A system, comprising:
a head-mounted support structure;
a display coupled to the head-mounted support structure that is configured to provide an image containing computer-generated content;
a gaze tracker; and
an optical assembly that provides the image to an eye box, wherein the optical assembly includes a waveguide that guides the image to an eye box, and an infrared-absorptive coating and an infrared-reflective coating that are configured to reduce an amount of environmental infrared light that reaches the gaze tracker.

20. The system defined in claim 19 wherein the gaze tracker comprises an infrared emitter and an infrared detector, wherein the infrared-reflective coating is a dichroic filter, and wherein the dichroic filter and the infrared-reflective coating are configured to reduce a thermal load on an internal portion of the head-mounted support structure.
